(19) United States
(12) Patent Application Publication
(10) Pub. No.: US 2024/0159170 A1
(43) Pub. Date: May 16, 2024

(54) ON-DEMAND HYDROGEN FOR POWER GENERATION

(71) Applicant: SIEMENS ENERGY GLOBAL GMBH & CO. KG, Munich (DE)

(72) Inventors: Gilles Bourque, Léry (CA); Jocelyn Blanchet, Saint-Polycarpe (CA); Jeffrey Myles Bergthorson, Montreal-West (CA); Keena Trowell, Montréal (CA)

(21) Appl. No.: 18/281,810

(22) PCT Filed: Apr. 6, 2022
(86) PCT No.: PCT/US2022/023599

§ 371 Date: Sep. 13, 2023

Related U.S. Application Data
(60) Provisional application No. 63/172,363, filed on Apr. 8, 2021.

(51) Int. Cl. F01K 21/04; F01K 23/14

(52) U.S. Cl. CPC F01K 21/047; F01K 23/14; F05D 2210/11; F05D 2220/722; F05D 2240/60; F05D 2260/205; F05D 2260/213; F05D 2270/303

(57) ABSTRACT

A power generation system includes a reactor operable to produce a flow of hydrogen and a flow of steam in response to the receipt of a flow of reactant mixture. A combustor is operable to produce a flow of combustion gas in response to the receipt of the flow of hydrogen and a first portion of the flow of steam, a turbine is operable to produce rotation of a first shaft in response to the receipt of the flow of combustion gas, and a steam turbine is operable to produce rotation of a second shaft in response to the receipt of a second portion of the flow of steam.

### BACKGROUND

Hydrogen has the potential to replace fossil fuels in many applications. However, most of the hydrogen produced today comes from methane reformation, a process that relies on fossil fuels and releases greenhouse gases. Hydrogen can also be produced using electrolysis, a technique that uses an electric current to split a water molecule into its constituent hydrogen and oxygen. This process does not produce greenhouse gas emissions, but its cost can be prohibitive as it requires a large amount of electricity. Independent of its production method, hydrogen cannot be stored and transported easily due to its large specific volume, its significant leakage rates, and its inherent safety risks. Thus, an efficient and scalable source of hydrogen that does not produce greenhouse gases and does not require storage or transportation is desirable in order to enable large scale power plant using hydrogen as a fuel to become economically and environmentally viable.

### SUMMARY

In one aspect, a power generation system includes a reactor operable to produce a flow of hydrogen and a flow of steam in response to the receipt of a flow of reactant mixture. A combustor is operable to produce a flow of combustion gas in response to the receipt of the flow of hydrogen and a first portion of the flow of steam, a turbine is operable to produce rotation of a first shaft in response to the receipt of the flow of combustion gas, and a steam turbine is operable to produce rotation of a second shaft in response to the receipt of a second portion of the flow of steam.

The power generation system may also include a mixture of aluminum and water as the flow of reactant mixture.

The power generation system may also include a generator coupled to the first shaft and the second shaft to produce electrical power in response to rotation of the first shaft and the second shaft.

The power generation system may also include a first generator coupled to the first shaft and operable to produce a first electrical power in response to rotation of the first shaft and a second generator coupled to the second shaft and operable to produce a second electrical power in response to rotation of the second shaft.

The power generation system may also include a reactor cooling system operable to deliver a flow of liquid water to the reactor to cool the reactor.

The power generation system may also include a generator coupled to the first shaft and the second shaft to produce electrical power in response to rotation of the first shaft and the second shaft.

In one aspect, a power generation system includes a reactor operable to produce a flow of hydrogen in response to the receipt of a flow of reactant mixture. A reactor cooling system is fluidly coupled to the reactor and is operable to produce a flow of steam in response to cooling the reactor. A combustion turbine includes a compressor operable to produce a flow of compressed air, a combustor operable to combust the flow of hydrogen and the flow of compressed air to produce a flow of combustion gas, and a turbine operable to produce rotation of a first shaft in response to the receipt of the flow of combustion gas. A first generator is coupled to the first shaft and is operable to generate a first electrical power in response to rotation of the first shaft. A steam turbine is operable to produce rotation of a second shaft in response to the receipt of the flow of steam, and a second generator is coupled to the second shaft and is operable to generate a second electrical power in response to rotation of the second shaft.

The power generation system may include a flow of reactant mixture that includes a mixture of aluminum and water.

The power generation system may also include a first generator coupled to the first shaft and operable to produce a first electrical power in response to rotation of the first shaft and a second generator coupled to the second shaft and operable to produce a second electrical power in response to rotation of the second shaft.

The power generation system may also include a reactor cooling system operable to deliver a flow of liquid water to the reactor to cool the reactor.

In another aspect, a method of producing electrical power includes delivering a flow of reactant mixture to a reactor, the flow of reactant mixture including a metal and water, operating the reactor to produce a flow of hydrogen and a quantity of heat, and cooling the reactor using a cooling system. The cooling process includes producing a flow of steam. The method further includes combusting the hydrogen within a combustor to produce a flow of combustion gas, passing the flow of combustion gas through a turbine to rotate a first shaft, and directing the flow of steam through a steam turbine to rotate a second shaft.

The method may also include a flow of reactant mixture that includes aluminum.

The method may also include coupling a generator to the first shaft and the second shaft to generate electrical power in response to the rotation of the first shaft and the second shaft.

The method may also include coupling a first generator to the first shaft and a second generator to the second shaft to generate electrical power in response to the rotation of the first shaft and the second shaft.

The method may also include producing a second flow of steam within the reactor by heating the flow of fuel and directing the second flow of steam from the reactor to the steam turbine.

The method may also include discharging the flow of combustion gas from the turbine and directing the flow of combustion gas to a heat exchanger to heat a flow of water for addition to the steam turbine.

The power generation system may also include converting the flow of liquid water to a second flow of steam in response to cooling the reactor.

The power generation system may also include directing the second flow of steam to the steam turbine.

Other technical features may be readily apparent to one skilled in the art from the following figures, descriptions, and claims.

The foregoing has broadly outlined some of the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the Detailed Description below, it should be understood that various definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

To easily identify the discussion of any particular element or act, the most significant digit or digits in a reference number refer to the figure number in which that element is first introduced.

FIG. 1 is a perspective view of an energy conversion device in the form of a reactor.

FIG. 2 is a perspective view of a portion of a jacket of the reactor of FIG. 1.

FIG. 3 is a section view of the reactor of FIG. 1.

FIG. 4 is a schematic illustration of an energy conversion system that uses the byproducts of the reactor of FIG. 1

FIG. 5 is a schematic illustration of a reactor similar to the reactor of FIG. 1.

FIG. 6 is a schematic illustration of a power plant including the reactor of FIG. 5.

FIG. 7 is a schematic illustration of a portion of the power plant of FIG. 6 including an alternative arrangement.

FIG. 8 is a flow chart of a method of operating the power plant of FIG. 6.

### DETAILED DESCRIPTION

Before any embodiments of the invention are explained in detail, it is to be understood that the invention is not limited in its application to the details of construction and the arrangement of components set forth in this description or illustrated in the following drawings. The invention is capable of other embodiments and of being practiced or of being carried out in various ways. Also, it is to be understood that the phraseology and terminology used herein is for the purpose of description and should not be regarded as limiting.

Various technologies that pertain to systems and methods will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

Also, it should be understood that the words or phrases used herein should be construed broadly, unless expressly limited in some examples. For example, the terms “including,” “having,” and “comprising,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Furthermore, while multiple embodiments or constructions may be described herein, any features, methods, steps, components, etc. described with regard to one embodiment are equally applicable to other embodiments absent a specific statement to the contrary.

Although the terms “first”, “second”, “third” and so forth may be used herein to refer to various elements, information, functions, or acts, these elements, information, functions, or acts should not be limited by these terms. Rather these numeral adjectives are used to distinguish different elements, information, functions or acts from each other. For example, a first element, information, function, or act may be termed a second element, information, function, or act, and, similarly, a second element, information, function, or act may be termed a first element, information, function, or act, without departing from the scope of the present disclosure.

In addition, the term “adjacent to” may mean that an element is relatively near to but not in contact with a further element or that the element is in contact with the further portion, unless the context clearly indicates otherwise. Further, the phrase “based on” is intended to mean “based, at least in part, on” unless explicitly stated otherwise. Terms “about” or “substantially” or like terms are intended to cover variations in a value that are within normal industry manufacturing tolerances for that dimension. If no industry standard is available, a variation of twenty percent would fall within the meaning of these terms unless otherwise stated.

The devices and systems described herein aim to reduce CO₂ (Carbon Dioxide) and NOₓ production from a turbine and enhance overall efficiency. The systems and devices make use of metal combustion to produce hydrogen on demand. The systems and devices provide for distributed energy production using hydrogen as a fuel but without the difficulty and safety issues associated with hydrogen storage or transportation.

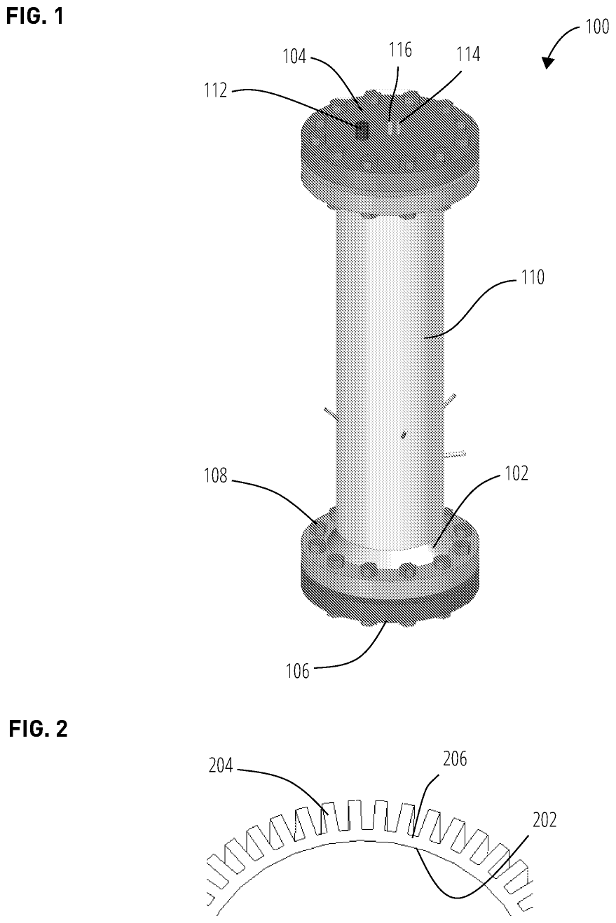

FIG. 1 illustrates a reactor 100 that includes a reactor vessel 102, a top cover 104, and a bottom cover 106. A number of bolts 108 are used to attach each of the top cover 104 and bottom cover 106 to the reactor vessel 102. Other constructions may employ other fasteners or other means of attaching the top cover 104 or the bottom cover 106 to the reactor vessel 102. One or more layers of insulation 110 may be wrapped around the reactor vessel 102.

As will be discussed in greater detail, the reactor 100 includes a coolant outlet 112, a gas outlet 114, and a nozzle 116 that each extend through the top cover 104. Of course, other constructions may position the gas outlet 114 and the nozzle 116 in other locations so that they do not pass through the top cover 104 but rather pass through an upper portion of the reactor vessel 102.

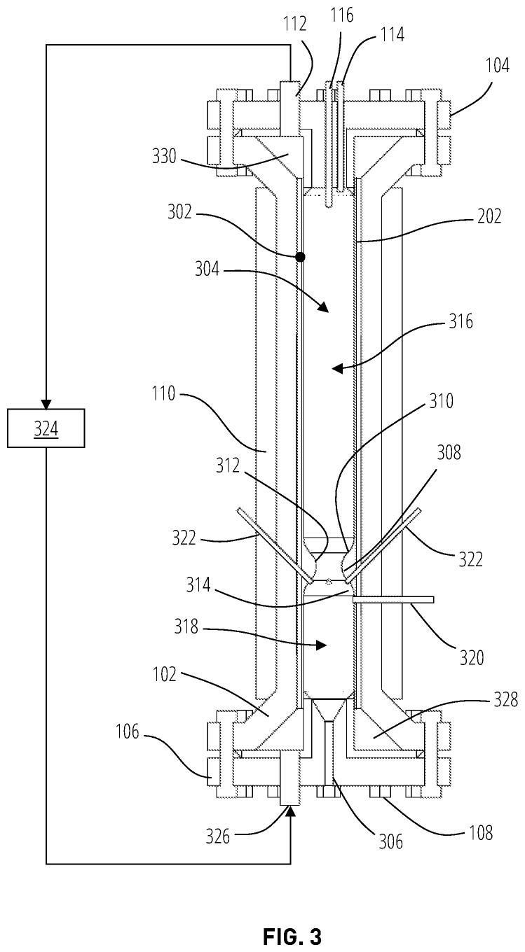

FIG. 3 is a section view of the reactor 100 of FIG. 1 which better illustrates the internal components. The reactor 100 includes a jacket 202 disposed within the reactor vessel 102. The jacket 202 may include one or more fins 204 (best illustrated in FIG. 2) that extend along the long axis of the jacket 202 and function to enhance the heat transfer efficiency of the jacket 202. The fins 204 are illustrated as having a rectangular cross section. However, any shape or arrangement could be employed for the fins 204 to enhance the heat transfer.

The jacket 202 cooperates with the reactor vessel 102 to define a cooling space 302 therebetween. In some constructions, the fins 204 are sized such that they do not contact the reactor vessel 102. In this arrangement a single continuous cooling space 302 is formed. In other constructions, some or all the fins 204 may contact an inner surface of the reactor vessel 102 such that the cooling space 302 includes multiple separated channels that extend along the length of the jacket 202.

Returning to FIG. 3, the jacket 202 includes an elongated wall that defines a chamber 304 and has a first end that receives the nozzle 116 and provides access for the gas outlet 114. A second end, opposite the first end provides access to a reaction product outlet 306 where reaction products are discharged from the chamber 304 defined by the jacket 202. In preferred arrangements, the jacket 202 and the reactor vessel 102 in which the jacket 202 is housed include elongated cylindrical portions that are arranged vertically with the first end above the second end. However, other arrangements and orientations may be possible.

To enhance operation, the jacket 202 may include a constriction 308 or narrow region of the inner surface. The outer surface of the jacket 202 may remain cylindrical such that the wall thickness near the constriction 308 is greater, or the wall thickness may be maintained with or without longer fins being employed.

In the illustrated construction, the constriction 308 includes a converging portion 310, a throat 312, and a diverging portion 314 such that it is shaped like a converging-diverging venturi with other shapes or arrangements being possible. The shape of the constriction 308 provides a local acceleration of the flow therethrough to hydrodynamically separate the components in the flow. The constriction 308 is positioned between 60 percent and 80 percent of the length of the jacket 202 with more preferred arrangements being between 65 percent and 75 percent. Thus, the constriction 308 divides the chamber 304 into an upper space 316 above the constriction 308 and a lower space 318 below the constriction 308.

In some constructions, a lower gas outlet 320 is provided below the constriction 308. As illustrated in FIG. 3, the lower gas outlet 320 is positioned in the uppermost portion of the lower space 318. However, other constructions may position the lower gas outlet 320 at a lower point within the lower space 318 or may position the lower gas outlet 320 in the constriction 308 below the throat 312 of the constriction 308.

The construction illustrated in FIG. 3 also includes one or more quench nozzles 322 positioned in the constriction 308. In the illustrated construction, the quench nozzles 322 are arranged such that they are normal to the inner surface of the diverging portion 314 of the constriction 308. Of course, other orientations are possible. In addition, while FIG. 3 illustrates two quench nozzles 322 and FIG. 1 illustrates three with a fourth hidden, arrangements with any number of quench nozzles 322 are possible.

The reaction product outlet 306 is positioned beneath the lower space 318 and includes a funnel shaped opening arranged to collect reaction products and discharge them from the chamber 304.

As will be discussed in greater detail, the reactor 100 is intended to perform an exothermic reaction such that some form of cooling will be used to maintain the reaction products within the chamber 304 in a desired temperature range. As illustrated in FIG. 3, a cooling system 324 provides a flow of coolant (e.g., water) to a coolant inlet 326. The coolant enters the reactor vessel 102 and is collected in a coolant inlet annulus 328. From the coolant inlet annulus 328 the coolant is distributed around the jacket 202 such that it is evenly distributed around the jacket 202 and the fins 204. The coolant flows upward through the cooling space 302 and is collected at a coolant outlet annulus 330 above the jacket 202. The fluid is discharged from the coolant outlet annulus 330 via the coolant outlet 112. It should be noted that while the coolant inlet 326 and the coolant outlet 112 are illustrated as passing through the bottom cover 106 and the top cover 104 respectively, other constructions may position the coolant inlet 326 and the coolant outlet 112 in other locations such as near the ends of the reactor vessel 102.

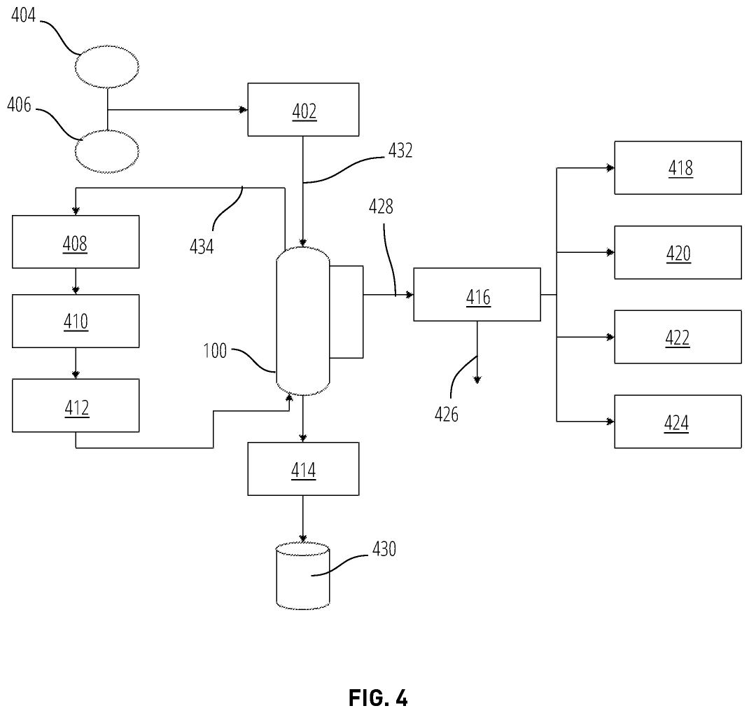

As will be discussed in greater detail with regard to FIG. 4, the cooling system 324 could include a simple system that includes a pump and a heat exchanger or could be a more complex system that uses the rejected heat to generate electrical power.

In operation, the reactor 100 receives a continuous flow of reactant mixture via the nozzle 116. The term fuel as used herein includes a mixture of water and at least one of aluminum (Al), boron (B), magnesium (Mg), silicon (Si), titanium (Ti), manganese (Mn), zinc (Zn), and alloys or compounds thereof. The water in the mixture actually functions as an oxidizer while the metal or alloy is the fuel. As used herein with regard to the fuel, the term “alloys” should be read to include traditional alloys as well as oxides or other compounds that contain one of the elements suitable for use as the fuel.

The reactor 100 is intended to operate as a continuous-flow reactor 100. Thus, fuel is continuously added to the reactor 100 while reaction product and gas (e.g., hydrogen) are continuously removed from the reactor 100 via the reaction product outlet 306 and the gas outlet 114 respectively.

In addition, the reactor 100 is intended to be supercritical. To achieve this, the fuel is delivered at a pressure greater than 221 bar such as between 221 and 350 bar. However, other reactors may operate in a sub-critical mode with temperatures ranging from 200 to 800 degrees Celsius and a pressure range such as a pressure of 155 bar or more. In addition, the temperature within the chamber 304 is maintained between 374 and 800 degrees Celsius with a more preferred range being between 374 and 475 degrees Celsius. To be considered a supercritical reaction, the temperature must be maintained above 374 degrees Celsius and pressure above 221 bar.

The following discussion will be specific to a process that uses aluminum as part of the fuel. However, as is clear, other fuels could be employed. Within the reactor 100, when using a fuel that contains aluminum, one of two reactions are expected depending upon the temperature within the chamber 304. Specifically, when operating between 374 degrees Celsius and 475 degrees Celsius, the reaction 2Al+4H₂O→2AlO(OH)+3H₂+846 kJ is expected to dominate. When the temperature within the chamber 304 is between 475 degrees Celsius and 600 degrees Celsius the reaction 2Al+3H₂O→Al₂O₃+3H₂+817 kJ is expected to dominate.

The first reaction describes the conversion of aluminum and water into aluminum oxyhydroxide (AlOOH), and hydrogen. Aluminum oxyhydroxide can also be referred to as boehmite. As noted above, below 475 degrees Celsius, aluminum oxyhydroxide is the most stable product. However, above 475° C., aluminum oxide (Al₂O₃) is the most stable product. As discussed, both reactions are highly exothermic. The cooling system 324 operates to extract at least a portion of this energy to control the temperature of the chemical reaction within the chamber 304.

By operating the reactor 100 in a supercritical temperature and pressure range, the reactor 100 provides a full yield of the metal-water reaction (i.e., between 90% and 100% conversion) without the need for a catalyst or any additives. In addition, the process does not require disruption of the passivating layer of the metal, through a chemical agent or a mechanical manipulation. Further, the reactor 100 can use coarsely produced metal powders, chips, or scrap fragments, and metal particle sizes ranging from micron to centimeter scale.

The reactor 100, and specifically, the upper space 316 of the jacket 202 defines a supercritical reaction zone where the supercritical aluminum-water reactions described above take place. This zone is maintained at a pressure between 221 bar and 350 bar, and at a temperature between 374° C. and 800° C. The combination of these pressures and temperatures can be described as supercritical. These supercritical conditions are used to provide high reaction rates and complete reaction of the aluminum with water.

The lower space 318, disposed beneath the constriction 308 defines a high-pressure quench zone where pressure remains above 221 bar, but the temperature is reduced below 374° C. (sub-critical). Water injection via the quench nozzles 322 can reduce the temperature in the lower space 318. In addition, the cooling system 324 can be operated or arranged to provide additional cooling in this region (e.g., coolant inlet 326 near the bottom). Temperature and pressure conditions are chosen to provide for liquid phase water in the lower space 318.

The fuel is injected via the nozzle 116 as a slurry of aluminum particles and liquid water that is compressed to a pressure slightly above the pressure within the upper space 316. The slurry feed of fuel (e.g., aluminum and water) can be preheated using heat from the reactor 100, from the reactor outputs, or from the cooling system 324. This heat exchange can be direct or can involve an intermediate heat exchange loop of fluid.

The reaction products (e.g., H₂, AlOOH, and Al₂O₃) and excess water leave the reactor 100 through the gas outlet 114 (H₂), the lower gas outlet 320 (H₂), and the reaction product outlet 306 (reaction products, any solids, and water). The location of the gas outlet 114 and the lower gas outlet 320 are selected such that buoyancy, or gravitational separation, restrict heavier solid oxides (AlOOH and Al₂O₃) and liquid water (H₂O) from entry.

The heat produced by the reaction is removed from the chamber 304 by the jacket 202 and fins 204. In other arrangements, the jacket 202 includes one or more tubes wrapped around the jacket 202. In addition to facilitating cooling, the jacket 202 is formed from a corrosion-resistant material to protect the reactor vessel 102 from corrosion.

As discussed, the cooling system 324 typically includes water as a coolant. However, other coolants such as CO₂, molten salts, or organic fluids could be employed. When water is used, it is preferred that the water enter the reactor 100 as a liquid and exit as a saturated vapor or a superheated vapor. The direction of the coolant flow from the bottom of the reactor 100 to the top of the reactor 100 aids in managing heat transfer temperatures since the cooling fluid is at a lowest temperature when passing the lower-temperature lower space 318 and reaches its highest temperature when passing the higher-temperature upper space 316.

As discussed, the quench nozzles 322 are provided to cool the contents of the chamber 304. The quench nozzles 322 preferably inject liquid water to reduce the temperature in the lower space 318. This cools the oxide particles (AlOOH and Al₂O₃) for improved handling as they leave the reactor 100. This water injection also ensures any undesired chemical reaction is quenched by temperature reduction. Optionally, this water injection can be used to produce an AlOOH/Al₂O₃-water slurry that reduces erosion caused by oxide particles leaving the reactor 100.

The solid products of the reaction (i.e., oxide particles, AlOOH, Al₂O₃) collect by gravity at the bottom of the lower space 318 and leave the system as AlOOH or Al₂O₃ particles, or as a water-AlOOH/Al₂O₃ slurry via the reaction product outlet 306. The geometry of the reaction product outlet 306 may vary based on the downstream interface with auxiliary systems, which may include a lock-hopper and valves for pressure reduction of the reaction products. In some constructions, an additional liquid-water outlet port may be installed in the lower space 318. Excess liquid water could be sieved/filtered away from the slurry and evacuated separately by this port.

During steady-state operation, the reactor 100 allows for a self-sustaining continuous flow operation. Once the steady flow of reactant mixture (i.e., water and metal) is sprayed into the upper space 316, it is heated by the surrounding heat of reaction and starts reacting. The exothermic reaction is maintained at constant temperature by the cooling flow within the cooling space 302.

The size of the upper space 316 is selected to allow sufficient residence time (e.g., between 30 seconds and 70 minutes) for chemical conversion to be complete. The mixture flows downward through the upper space 316 until it passes the constriction 308 and the quench water that is injected via the quench nozzles 322. The quench water reduces the temperature of the reactants and products of reaction without significantly reducing the pressure. As the temperature drops in the lower space 318, some water may condense into a liquid state and collect at the bottom of the lower space 318 with the AlOOH and/or Al₂O₃ particles where they can be discharged via the reaction product outlet 306 as a liquid or slurry. The lighter gases (e.g., H₂ and steam) being more buoyant remain above the liquid water and oxide particles and can escape continuously through the lower gas outlet 320. These gaseous products being also lighter than the supercritical water and fuel mixture can also accumulate above the upper space 316 where they can escape through the gas outlet 114. To enhance buoyancy (gravitational separation) and reduce turbulence, long residence times and low flow velocities within the reactor 100 are preferred.

During start-up of the reactor 100, the necessary heat for the reaction is not present. As such, during start-up, the reactor 100 is initially operated in a batch mode. The reactor 100 is partially filled with fuel (e.g., a mixture of aluminum and water) and the nozzle 116, the gas outlet 114, the lower gas outlet 320, the quench nozzles 322, and the reaction product outlet 306 are all closed. Once the reaction starts and the temperature and pressure within the reactor 100 increase towards the critical point, the gas outlet 114 and the lower gas outlet 320 open and enable steam/hydrogen to escape. Additional water may be injected to maintain the reaction during this phase.

Once the critical point of water is reached within the upper space 316, the batch mode continues to operate until the rate of hydrogen production starts to decrease. At this point, additional fuel (e.g., aluminum-water slurry) is injected through the nozzle 116 into the upper space 316, and the products of the reaction are removed from the lower space 318 through the reaction product outlet 306. The reactor 100 can then be switched to continuous operation, with continuous cooling flow from the cooling system 324 and quench water flow via the quench nozzles 322.

When the system is initially filled with aluminum and water, the initial onset of the reaction that leads to the thermal build-up needs to be enhanced. For this, various strategies can be used including adding aluminum oxyhydroxide (AlOOH) in the start-up mixture, using ultra-fine aluminum powder, adding external heat to the fuel or the reactor 100, or the use of catalysts or other additives.

While the reactor 100 is itself an energy conversion system that uses a chemical process to convert the chemical energy of the fuel into heat and a combustible gas, FIG. 4 illustrates some examples of other energy conversion systems that use the outputs or converted energy from the reactor 100 to provide energy in a desired form (e.g., electrical power, heat) for further use or conversion.

As discussed, the reactor 100 is capable of operating using a number of different fuels. However, the description of FIG. 4 will continue the example that uses aluminum as the fuel despite the reactor 100 of FIG. 4 being well-suited for use with many other fuels. Using this fuel, the reactor 100 produces heat and hydrogen as usable outputs.

With reference to FIG. 4, a supply of a metal 404 (e.g., aluminum, aluminum compounds, oxides, etc.) and a supply of water 406 is directed to devices that provide mixing and compression 402. The compression raises the pressure of the now mixed fuel 432 to the desired pressure level for the reactor 100. The fuel 432 passes through the reactor 100 as discussed with regard to FIG. 1 through FIG. 3 to produce heat, and more specifically, saturated or superheated steam 434, and hydrogen 428.

The steam 434 is directed to a steam turbine 408 where it operates to drive the steam turbine 408 and any component attached thereto. In most arrangements, an electrical generator is coupled to the steam turbine 408 such that the generator produces electrical power in response to the flow of steam 434. As discussed, the reactor 100 produces a significant amount of heat during the reaction. In one construction, a flow of 1 kg/s of aluminum fuel produces about 15.7 MW of heat energy which leads to enough steam 434 to generate about 3.9 MW of electricity via the steam turbine 408 and the generator. This results in a 25% steam-turbine-generator efficiency.

After the steam 434 passes through the steam turbine 408 the steam 434 is directed to a coolant condenser 410 where it is condensed to a liquid state. A pump 412 then pumps the water back to the reactor 100 to complete the cooling cycle.

The hydrogen 428 exits the reactor 100 as described and first passes through a condenser 416 where any water or steam that may be mixed with the hydrogen 428 is separated to produce dry hydrogen. The dry hydrogen can be used in one or more of a number of different energy conversion devices. For example, the hydrogen could be combusted, either alone or as an additive to another fuel in a turbine 418, a reciprocating engine 420, or any other engine 422. The turbine 418, reciprocating engine 420, and/or other engine 422 could drive a generator that in turn generates electrical power (AC or DC) or current at a voltage as may be desired. In addition, the hydrogen 428 can be used in a fuel cell 424 to directly generate electrical power if desired. Of course, there are many other suitable uses for hydrogen (e.g., chemical processes, fertilizer manufacture, etc.) where the hydrogen could be used if desired.

The aluminum oxide products exiting the reactor 100 through a pressure reduction device 414, such as a lock-hopper, to be stored in a storage tank 430 at reduced pressure.

The system shown in FIG. 4 may include additional sub-systems to improve efficiency or reduce water consumption. For example, an expander can be used to extract work from the hydrogen 428 before it enters the condenser 416 or passes through the condenser 416. For example, a heat exchanger can be used to extract heat from the product streams (either upstream of the pressure reducer 414 or upstream of the condenser 416, or in place of the condenser 416 as a combined recuperator and condenser) to preheat the incoming reactants (metal 404 and water 406) either upstream of the mixing and compression 402 or after the mixing and compression 402. For example, condensed water or condensate 426 from the condenser 416 or filtered water taken upstream of the pressure reducer 414, can be re-injected into the reactants before or after the mixing and compression 402.

The system illustrated herein is also capable of generating about 400 kg of hydrogen per hour in response to a flow of reactant mixture that contains 1 kilogram of aluminum per second as an example.

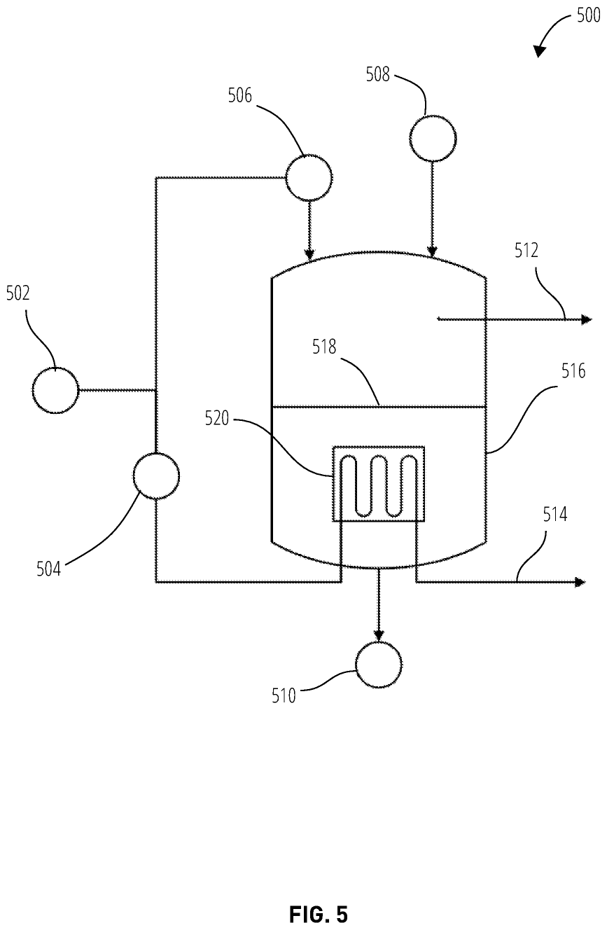

FIG. 5 schematically illustrates a reactor 500 that is similar to those described with regard to FIG. 1 through FIG. 4. The reactor 500 includes a reactor vessel 516 that may contain a fluid and a gas separated at a liquid line 518 or alternatively includes a single-phase fluid (e.g., supercritical). A cooling system 520 is provided to cool the reactor 500 during operation to maintain the most desirable operating temperature.

A source of water 502 provides a flow of cooling water 504 that is delivered to the cooling system 520 for use in cooling the reactor 500 during operation. In the illustrated construction, the cooling water 504 is delivered to the cooling system 520 in liquid form and is discharged via a steam outlet 514 in the form of saturated or superheated steam. It should be understood that fluids other than water could be employed as a coolant. However, water has the advantage that it is discharged as steam which can be directly used in a steam turbine. Other coolants may require a heat exchanger to utilize the waste heat collected by the coolant.

Water is also directed from the source of water 502 to a water inlet 506 where it is injected into the reactor vessel 516. A metal inlet 508 provides an inlet point for the addition of a metal, such as aluminum into the reactor vessel 516. The water injected via the water inlet 506 and the metal injected via the metal inlet 508 cooperate to define a flow of reactant mixture into the reactor 500.

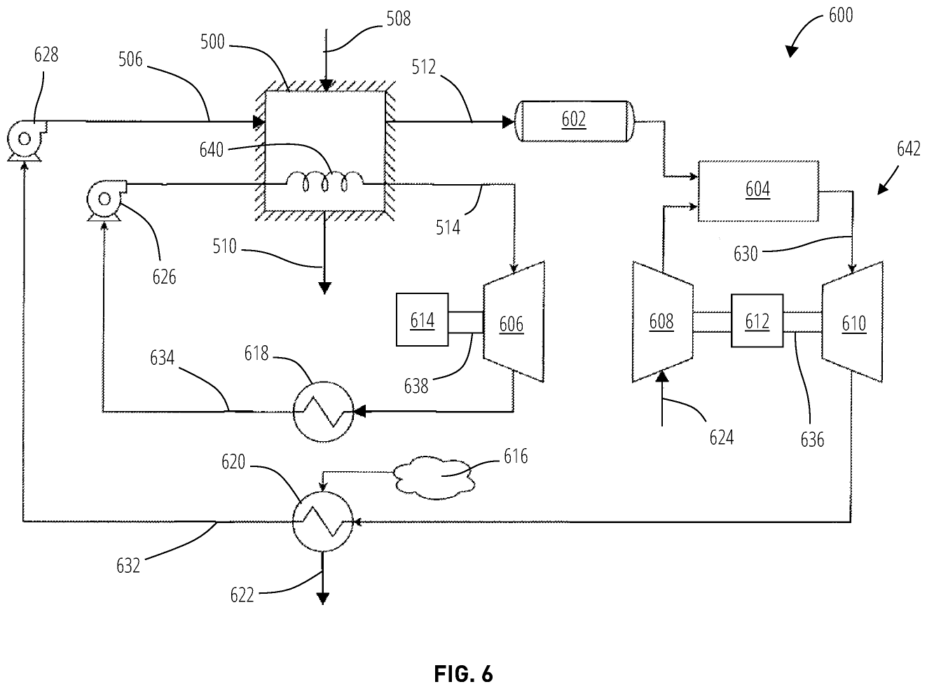

During the operation of the reactor 500, the metal, in this example aluminum reacts with the water to form an oxide of aluminum (e.g., aluminum oxide, Al₂O₃), a flow of hydrogen, and a significant amount of heat as the reaction is exothermic. The cooling system 520 removes the excess heat as discussed earlier. The reaction products (i.e., the oxides) exit the reactor vessel 516 via a reaction product outlet 510 and the flow of hydrogen exits the reactor vessel 516 via the hydrogen outlet 512. Typically, the flow of hydrogen also includes some steam that is produced within the reactor 500 and can be directed to a steam turbine 606 as discussed with regard to FIG. 6.

FIG. 6 schematically illustrates an example of one possible power plant 600 that could be operated using the reactor 500 of FIG. 5 as a source of energy. The reactor 500 receives the metal component of the fuel via the metal inlet 508 as described with regard to FIG. 5. In addition, the reaction products (i.e., the oxides) are discharged from the reactor 500 via the reaction product outlet 510. A water loop 632 provides for the flow of water into the reactor 500 via the water inlet 506 and extracts the hydrogen and some steam out of the reactor 500 via the hydrogen outlet 512. A coolant loop 634 provides liquid water to the cooling system 520 and extracts steam from the reactor 500 via the steam outlet 514 as discussed with regard to FIG. 5.

The water loop 632 includes a water pump 628 that pumps the liquid water into the reactor 500 via the water inlet 506. Following reaction within the reactor 500, the flow of hydrogen exits the reactor 500 via the hydrogen outlet 512 and may be collected in one or more hydrogen tanks 602 that operate to store the hydrogen and, in some cases, separate excess steam from the flow of hydrogen. The separated excess steam, if present can be directed to a steam turbine 606 or to another point of use as may be desired.

A gas turbine 642 is connected to the water loop 632 to receive the flow of hydrogen for operation. The gas turbine 642 includes a compressor 608 that receives a flow of air 624 and compresses that flow of air 624 for delivery to a combustor 604. The combustor 604 receives the flow of hydrogen and the compressed flow of air 624, combines the flows, and combusts them to produce a flow of combustion gas 630. A turbine 610 receives the flow of combustion gas 630 and operates in response to the passage of the flow of combustion gas 630 therethrough to drive the compressor 608 and a first generator 612 via rotation of a first shaft 636. The first generator 612 operates in response to rotation of the first shaft 636 to generate electrical power.

The flow of combustion gas 630 may then be directed to a heat exchanger 620 (e.g., heat recovery steam generator) where a portion of the excess heat from the flow of combustion gas 630 may be used to heat a fluid such as water 616 to produce steam 622. The steam 622 can then be directed to the steam turbine 606 for use or to another point of use as may be desired.

Any water that condenses from the flow of combustion gas 630 may be redirected to the water pump 628 to complete the water loop 632. While not shown, make-up water can be provided to the water pump 628 to assure that the necessary quantity of water is delivered to the reactor 500.

The coolant loop 634 or cooling system 520 includes a coolant pump 626 that operates to circulate a coolant, typically water through the coolant loop 634. A heat exchanger 640 disposed within the reactor 500 or formed as part of the reactor 100 operates to extract excess heat from the reactor 500, 100 to maintain a desired operating temperature within the reactor 500, 100. As discussed, the coolant is delivered to the heat exchanger 640 as liquid water and is discharged via the steam outlet 514 as a flow of steam. The flow of steam may be combined with steam from the hydrogen tank 602 or from the heat exchanger 620 before being directed to the steam turbine 606. The flow of steam passes through the steam turbine 606 which operates to rotate a second shaft 638 that in turn rotates a second generator 614 to generate electrical power.

The steam that exits the steam turbine 606 is then directed to a condenser 618 where the steam is condensed to water. The coolant pump 626 then draws the water from the condenser 618 to complete the coolant loop 634.

It should be noted that the foregoing describes the system that uses water for a coolant and aluminum as the metal component of the fuel. However, other arrangements could employ other metals and other coolants as may be desired.

In addition, while two generators 612, 614 are described as being separately driven by the gas turbine 642 and the steam turbine 606, other constructions may employ a single generator driven by each of the gas turbine 642 and the steam turbine 606.

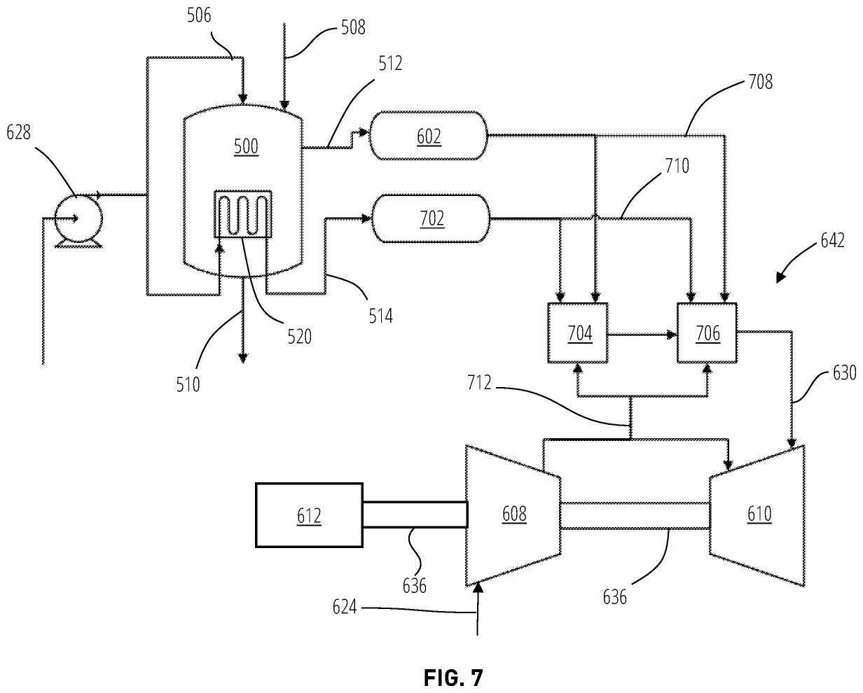

FIG. 7 illustrates a variation of the power plant 600 that affects the operation of the gas turbine 642. The water pump 628 and the reactor 500 operate much like that described with regard to FIG. 6. The hydrogen, along with some steam is delivered via the hydrogen outlet 512 to the hydrogen tank 602. Water from the cooling system 520, in the form of steam, is delivered via the steam outlet 514 to a water tank 702 where the steam can be collected.

The combustor 604 of the gas turbine 642 includes a primary combustion section 704 and a secondary combustion section 706 in which combustion of the fuel takes place. A flow of hydrogen 708 passes from the hydrogen tank 602 to each of the primary combustion section 704 and the secondary combustion section 706 where it is mixed with a flow of compressed air 712 and combusted. Following combustion in the primary combustion section 704, products of combustion are delivered to the secondary combustion section 706 for an additional combustion cycle prior to being directed to the turbine 610 as a flow of combustion gas 630.

A portion of the flow of steam 710 can be used to inject supplementary steam into the combustor 604. Specifically, a portion of the flow of steam 710 can be directed into one or both of the primary combustion section 704 and the secondary combustion section 706. The addition of steam in the primary combustion section 704 and the secondary combustion section 706 permits improvement of the stoichiometry of the different combustion sections to minimize NO emissions and to control thermo-acoustic instabilities. In addition, the addition of steam into the combustor 604 enhances cycle efficiency and reduces the likelihood of flashback.

The control of emissions (i.e., carbon dioxide and NOₓ) may be achieved by closely monitoring and controlling the parameters of the compounds delivered to the combustor and specifically to the primary combustion section 704 and the secondary combustion section 706. For example, one arrangement maintains the combustion temperatures in each of the primary combustion section 704 and the secondary combustion section 706 below a predetermined temperature to provide for the minimization of NOₓ emissions. This can be achieved by closely monitoring and controlling the temperature, pressure, and quantity of steam injected into each of the primary combustion section 704 and the secondary combustion section 706. Closely monitoring and controlling the temperature, pressure, and quantity of hydrogen (as well as other fuel) delivered to each of the primary combustion section 704 and the secondary combustion section 706 can also improve the operation and reduce the undesirable emissions. The temperature of the hydrogen, as well as any other fuel and the steam can also be tailored to compensate for variations of the ambient temperature.

The proportion of hydrogen and steam can be tailored to optimize the combustion process stability and reduce the NOₓ emissions as the gas turbine is accelerated from ignition conditions to baseload conditions. The emissions of NOₓ can be controlled by an exchange of steam dilution and fuel flow which are also the key to control combustion stability, as both are changed without changing the overall output composition or temperature at the exit of the combustor.

The construction of FIG. 7 allows for the control of the quantity of hydrogen, steam, and in some cases compressed air to each of the primary combustion section 704 and the secondary combustion section 706. By carefully selecting the quantity and/or temperature of the steam delivered to the primary combustion section 704 and the richness of the primary combustion section 704, the combustion temperature of the primary combustion section 704 can be maintained at a desired temperature, thereby providing for low NOₓ emissions, and stable combustion for a wide range of operating conditions. Similarly, by carefully selecting the quantity and/or temperature of the steam delivered to the secondary combustion section 706 and the richness of the secondary combustion section 706, the combustion temperature of the secondary combustion section 706 can be maintained at a desired temperature, thereby providing for low NOₓ emissions, and stable combustion be achieved.

It should be understood that the portions of the power plant 600 of FIG. 6 not illustrated in FIG. 7 are omitted for clarity and could be included with the portion of the power plant illustrated in FIG. 7. For example, any steam not injected into the primary combustion section 704 and the secondary combustion section 706 can be directed to a steam turbine 606 as described with regard to FIG. 6.

In operation, a flow of reactant mixture in the form of a mixture of water and a metal such as aluminum is delivered to the reactor 500 via the water inlet 506 and the metal inlet 508. Within the reactor 500, an oxidation reaction takes place to produce hydrogen, a metal oxide (e.g., Al₂O₃), and heat. The cooling system 520 operates to maintain the reactor 500 at a desired temperature while also producing a flow of steam.

The hydrogen may be collected in the hydrogen tank 602 or may flow directly to the combustor 604 of the gas turbine 642 where it is mixed with compressed air produced by the compressor 608 and is combusted. As illustrated in FIG. 7, the combustion process may be divided into a primary combustion section 704 and a secondary combustion section 706 and may provide for the addition of steam in either of or both of the primary combustion section 704 and the secondary combustion section 706.

Following combustion, the flow of combustion gas 630 produced by the combustor 604 is directed to the turbine 610. The flow of combustion gas 630 produces rotation of the turbine 610 which drives the first shaft 636, the compressor 608, and the first generator 612.

The flow of steam may be directed to the steam turbine 606 to produce rotation of the steam turbine 606 which in turn drives the second shaft 638 and the second generator 614. It should be noted that the first generator 612 and the second generator 614 could be a single generator that is driven by both the gas turbine 642 and the steam turbine 606.

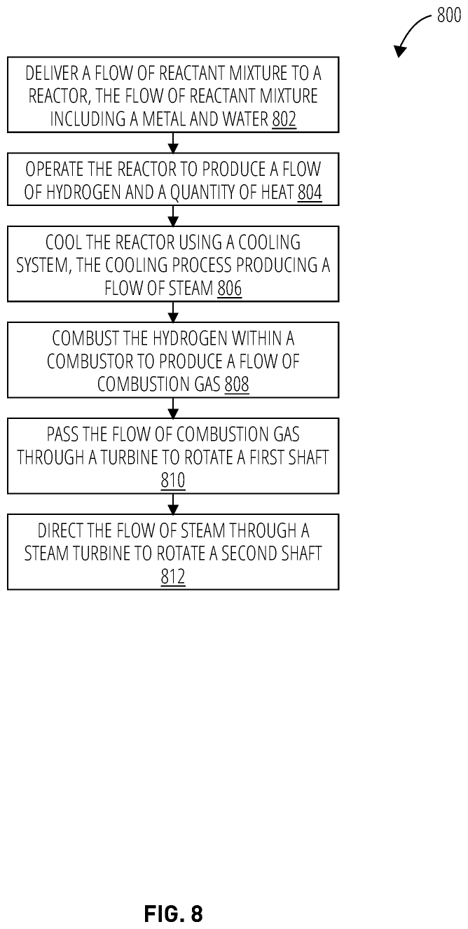

FIG. 8 includes a flow chart illustrating the general operation of a power plant 600. In block 802, the method of operating a power plant 800 delivers a flow of reactant mixture to a reactor, the flow of reactant mixture including a metal and water. In block 804, the method of operating a power plant 800 operates the reactor to produce a flow of hydrogen, a quantity of steam, and a quantity of heat. In block 806, the method of operating a power plant 800 cools the reactor using a cooling system, the cooling process producing a flow of steam. In block 808, the method of operating a power plant 800 combusts the hydrogen, and in some constructions steam within a combustor to produce a flow of combustion gas. In block 810, the method of operating a power plant 800 passes the flow of combustion gas through a turbine 610 to rotate a first shaft. In block 812, the method of operating a power plant 800 directs the flow of steam through a steam turbine to rotate a second shaft.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

What is claimed is:

1. A power generation system comprising:
a reactor operable to produce a flow of hydrogen and a flow of steam in response to the receipt of a flow of reactant mixture;
a combustor operable to produce a flow of combustion gas in response to the receipt of the flow of hydrogen and a first portion of the flow of steam;
a turbine operable to produce rotation of a first shaft in response to the receipt of the flow of combustion gas; and
a steam turbine operable to produce rotation of a second shaft in response to the receipt of a second portion of the flow of steam.

2. The power generation system of claim 1, wherein the flow of reactant mixture includes a mixture of aluminum and water.

3. The power generation system of claim 1, further comprising a generator coupled to the first shaft and the second shaft to produce electrical power in response to rotation of the first shaft and the second shaft.

4. The power generation system of claim 1, further comprising a first generator coupled to the first shaft and operable to produce a first electrical power in response to rotation of the first shaft and a second generator coupled to the second shaft and operable to produce a second electrical power in response to rotation of the second shaft.

5. The power generation system of claim 1, further comprising a reactor cooling system operable to deliver a flow of liquid water to the reactor to cool the reactor.

6. The power generation system of claim 5, wherein the flow of liquid water is converted to a second flow of steam in response to cooling the reactor.

7. The power generation system of claim 6, wherein the second flow of steam is directed to the steam turbine.

8. The power generation system of claim 1, wherein the combustor operates at a combustion temperature, and wherein the combustion temperature is maintained at a desired temperature in part in response to a temperature and a quantity of the flow of steam.

9. The power generation system of claim 1, wherein the combustor includes a primary combustion section and a secondary combustion section, the primary combustion section receiving a sub portion of the first portion of the flow of steam and the secondary combustion section receiving a remaining portion of the first portion of the flow of steam.

10. The power generation system of claim 9, wherein the primary combustion section operates at a primary combustion temperature and the secondary combustion section operates at a secondary combustion temperature, wherein the primary combustion temperature is maintained at a desired primary temperature in part in response to a temperature and a quantity of the sub portion of the first portion of the flow of steam, and wherein the secondary combustion temperature is maintained at a desired secondary temperature in part in response to a temperature and a quantity of the remaining portion of the first portion of the flow of steam.

11. The power generation system of claim 10, wherein the primary combustion temperature is maintained at the desired primary temperature in part in response to a temperature and a quantity of hydrogen delivered to the primary combustion section and wherein the secondary combustion temperature is maintained at the desired secondary temperature in part in response to a temperature and a quantity of hydrogen delivered to the secondary combustion section.

12. A power generation system comprising:
a reactor operable to produce a flow of hydrogen in response to the receipt of a flow of reactant mixture;
a reactor cooling system fluidly coupled to the reactor, the reactor cooling system operable to produce a flow of steam in response to cooling the reactor;
a combustion turbine including a compressor operable to produce a flow of compressed air, a combustor operable to combust the flow of hydrogen and the flow of compressed air to produce a flow of combustion gas, and a turbine operable to produce rotation of a first shaft in response to the receipt of the flow of combustion gas;
a first generator coupled to the first shaft and operable to generate a first electrical power in response to rotation of the first shaft;
a steam turbine operable to produce rotation of a second shaft in response to the receipt of the flow of steam; and
a second generator coupled to the second shaft and operable to generate a second electrical power in response to rotation of the second shaft.

13. The power generation system of claim 12, wherein the flow of reactant mixture includes a mixture of aluminum and water.

14. The power generation system of claim 12, further comprising a generator coupled to the first shaft and the second shaft to produce electrical power in response to rotation of the first shaft and the second shaft.

15. The power generation system of claim 12, further comprising a first generator coupled to the first shaft and operable to produce a first electrical power in response to rotation of the first shaft and a second generator coupled to the second shaft and operable to produce a second electrical power in response to rotation of the second shaft.

16. The power generation system of claim 12, further comprising a reactor cooling system operable to deliver a flow of liquid water to the reactor to cool the reactor.

17. The power generation system of claim 16, wherein the flow of liquid water is converted to a second flow of steam in response to cooling the reactor.

18. The power generation system of claim 17, wherein the second flow of steam is directed to the steam turbine.

19. The power generation system of claim 12, wherein the combustor operates at a combustion temperature, and wherein the combustion temperature is maintained at a desired temperature in part in response to a temperature and a quantity of the flow of steam.

20. The power generation system of claim 12, wherein the combustor includes a primary combustion section and a secondary combustion section, the primary combustion section receiving a sub portion of the first portion of the flow of steam and the secondary combustion section receiving a remaining portion of the first portion of the flow of steam.

21. The power generation system of claim 20, wherein the primary combustion section operates at a primary combustion temperature and the secondary combustion section operates at a secondary combustion temperature, wherein the primary combustion temperature is maintained at a desired primary temperature in part in response to a temperature and a quantity of the sub portion of the first portion of the flow of steam, and wherein the secondary combustion temperature is maintained at a desired secondary temperature in part in response to a temperature and a quantity of the remaining portion of the first portion of the flow of steam.

22. The power generation system of claim 21, wherein the primary combustion temperature is maintained at the desired primary temperature in part in response to a temperature and a quantity of hydrogen delivered to the primary combustion section and wherein the secondary combustion temperature is maintained at the desired secondary temperature in part in response to a temperature and a quantity of hydrogen delivered to the secondary combustion section.

23. A method of producing electrical power, the method comprising:
delivering a flow of reactant mixture to a reactor, the flow of reactant mixture including a metal and water;
operating the reactor to produce a flow of hydrogen and a quantity of heat;
cooling the reactor using a cooling system, the cooling process producing a flow of steam;
combusting the hydrogen within a combustor to produce a flow of combustion gas;
passing the flow of combustion gas through a turbine to rotate a first shaft; and
directing the flow of steam through a steam turbine to rotate a second shaft.

24. The method of claim 23, wherein the flow of reactant mixture includes aluminum.

25. The method of claim 23, further comprising coupling a generator to the first shaft and the second shaft to generate electrical power in response to the rotation of the first shaft and the second shaft.

26. The method of claim 23, further comprising coupling a first generator to the first shaft and a second generator to the second shaft to generate electrical power in response to the rotation of the first shaft and the second shaft.

27. The method of claim 23, further comprising producing a second flow of steam within the reactor by heating the flow of reactant mixture, and directing the second flow of steam from the reactor to the steam turbine.

28. The method of claim 23, further comprising discharging the flow of combustion gas from the turbine and directing the flow of combustion gas to a heat exchanger to heat a flow of water for addition to the steam turbine.

29. The method of claim 23, further comprising directing a flow of steam to the combustor and maintaining the combustor at a desired combustion temperature in part by controlling a temperature and a quantity of the flow of steam.

30. The method of claim 23, further comprising dividing the combustor into a primary combustion section and a secondary combustion section, delivering a first quantity of a flow of steam to the primary combustion section, and delivering a second quantity of steam to the secondary combustion section.

31. The method of claim 30, further comprising maintaining the primary combustion section at a primary combustion temperature and the secondary combustion section at a secondary combustion temperature to maintain the primary combustion temperature, controlling a temperature and a quantity of the first quantity of steam, and controlling a temperature and a quantity of the second quantity of steam of steam to in part maintain the secondary combustion temperature.

32. The power generation system of claim 31, wherein the primary combustion temperature is maintained at the desired primary temperature in part in response to a temperature and a quantity of hydrogen delivered to the primary combustion section and wherein the secondary combustion temperature is maintained at the desired secondary temperature in part in response to a temperature and a quantity of hydrogen delivered to the secondary combustion section.
